(19) United States
(12) Patent Application Publication
(10) Pub. No.: US 2014/0199604 A1
(43) Pub. Date: Jul. 17, 2014

(54) STABLE ION EXCHANGE FLUORINATED POLYMERS AND MEMBRANES OBTAINED THEREFROM

(71) Applicant: SOLVAY SPECIALTY POLYMERS ITALY S.p.A., Bollate (MI) (IT)

(72) Inventors: Marco Avataneo, Senago (IT); Claudio Oldani, Nerviano (MI) (IT); Giuseppe Marchionni, Milano (IT)

(73) Assignee: SOLVAY SPECIALTY POLYMERS ITALY S.p.A., Bollate (MI) (IT)

(21) Appl. No.: 14/123,926

(22) PCT Filed: May 31, 2012
(86) PCT No.: PCT/EP2012/060212

§ 371 Date: Mar. 17, 2014

(30) Foreign Application Priority Data
Jun. 6, 2011 (EP) 11168756.2

(51) Int. Cl. H01M 8/10

(52) U.S. Cl. CPC H01M 8/1039
USPC 429/408; 429/494

(57) ABSTRACT

A composition comprising at least one fluorinated polymer comprising —SO₂X functional groups, wherein X is selected from X′ or from OM and wherein X′ is selected from the group consisting of F, CI, Br, I and M is selected from the group consisting of H, alkaline metals, NH4, and at least one fluorinated aromatic compound. Ion conducting membranes comprising the composition have improved resistance towards radical degradation in fuel cell applications.

This application claims priority to European application No. 11168756.2 filed on Jun. 6, 2011 the whole content of this application being incorporated herein by reference for all purposes.

### TECHNICAL FIELD

The invention relates to compositions comprising ion exchange fluorinated polymers provided with improved resistance towards radical degradation and to the ion conducting membranes obtained therefrom.

### BACKGROUND ART

Fluorinated polymers containing sulfonic acid ion exchange groups, due to their ion conducting properties, have found widespread use in the manufacture of electrolyte membranes for electrochemical devices such as electrolysis cells and fuel cells. Notable examples are for instance proton exchange membrane (PEM) fuel cells which employ hydrogen as the fuel and oxygen or air as the oxidant.

In a typical PEM fuel cell, hydrogen is introduced into the anode portion, where hydrogen reacts and separates into protons and electrons. The membrane transports the protons to the cathode portion, while allowing a current of electrons to flow through an external circuit to the cathode portion to provide power. Oxygen is introduced into the cathode portion and reacts with the protons and electrons to form water and heat.

The membrane requires excellent ion conductivity, gas barrier properties (to avoid the direct mixing of hydrogen and oxygen), mechanical strength and chemical, electrochemical and thermal stability at the operating conditions of the cell. In particular, long-term stability of the membrane is a critical requirement: the lifetime goal for stationary fuel cell applications being up to 40,000 hours of operations, 20,000 hours of operation for automotive fuel cell applications.

Attack of the ion exchange membrane by hydrogen peroxide radicals (^{▪}OH, ^{▪}OOH), which are generated during fuel cell operation, has often been described as one of the causes of membrane degradation. Radical degradation of the membrane contributes to the reduction of the life of service of the fuel cell. It is generally believed that, among other mechanisms, hydrogen peroxide is formed as a result of the reaction between hydrogen and oxygen that permeate through the membrane. Hydrogen peroxide then decomposes to form peroxy and hydroperoxy radicals, see for instance SCHLICK, S., et al. Degradation of fuel cell membranes using ESR methods: ex situ and in situ experiments. Polymer Preprints. 2009, vol. 50, no. 2, p. 745-746. Direct formation of the radicals it is also believed to be possible.

Several attempts have been made to reduce radical degradation of fluorinated ion exchange membranes, for instance by incorporation into the membrane of suitable metallic salts or oxides. Both EP 1702378 A (BDF IP HOLDINGS LTD) Sep. 20, 2006 and EP 1662595 A (TOYOTA CHUO KENKYUSHO) May 31, 2006 disclose the use of salts of various metals, including rare earth metals, Al and Mn to increase the stability of ion exchange membranes for use in fuel cells.

On the other hand the use of organic compounds acting as radical scavengers has been proposed in WO 2009/109780 (JOHNSON MATTHEY LTD) Sep. 11, 2009. In particular, in WO 2009/109780 (JOHNSON MATTHEY LTD) Sep. 11, 2009 discloses the use of regenerative hindered amine stabilizers which are characterised by the presence of —NOR groups in the structure which can be regenerated during radical scavenging by a cyclic process (the so-called “Denisov cycle”).

From the forgoing it appears that the need still exists for providing fluorinated polymers containing sulfonic acid functional groups having improved resistance towards radical degradation.

### DISCLOSURE OF INVENTION

It has now been found that the addition of certain fluorinated aromatic compounds to fluorinated polymers containing sulfonic acid functional groups increases the stability of membranes prepared therefrom towards radical degradation. The increase in stability is reflected for instance in the longer life of service of the membrane when used in a fuel cell.

Fluorinated aromatic compounds are generally known in the art. The reactivity of certain fluorinated aromatic compounds towards radical addition reactions has been previously disclosed, for instance in KOBRINA, L. S. Some peculiarities of radical reactions of perfluoroaromatic compounds. J. Fluorine Chem. 1989, vol. 42, p. 301-344. Among the many radical addition reactions and reaction pathways disclosed in this article mention can be made of the reaction of perfluorinated aromatic compounds such as octafluoronaphtalene or hexafluorobenzene with peroxide radicals, such as those which are believed to participate in the ion exchange membrane degradation processes. The evidence reported in the above-referenced article indicates that such reactions may lead to the fragmentation of the perfluorinated aromatic compound with the generation of further organic radicals (ibid. page 339), available for further radical addition reactions.

US 20060083976 A (CALIFORNIA INSTITUTE OF TECHNOLOGY) Apr. 20, 2006 on the other hand discloses ion exchange membranes of fluorinated polymers containing sulfonic acid ion exchange groups comprising substituted imidazole or benzoimidazole compounds, including fluorinated imidazole or benzoimidazole compounds. The imidazole or benzoimidazole compounds are added as a water replacement in the membrane to provide it with ion exchange capabilities. The substituted imidazole or benzoimidazole compounds disclosed herein are however characterised by the presence of hydrogen atoms bound to the nitrogen atoms in the aromatic structure.

A first object of the present invention is thus a composition comprising at least one fluorinated polymer comprising —SO₂X functional groups, wherein X is selected from X′ or from OM and wherein X′ is selected from the group consisting of F, Cl, Br, I and M is selected from the group consisting of H, alkaline metals, NH₄, and at least one fluorinated aromatic compound.

The expression “fluorinated” is used herein to refer to compounds (e.g. compounds, polymers, monomers etc.) that are either totally or partially fluorinated, i.e. wherein all or only a part of the hydrogen atoms have been replaced by fluorine atoms. Preferably, the term “fluorinated” refers to compounds that contain a higher proportion of fluorine atoms than hydrogen atoms, more preferably the term refers to compounds that are totally free of hydrogen atoms, i.e. wherein all the hydrogen atoms have been replaced by fluorine atoms.

Within the context of the present invention the expression “at least one” when referred to a “fluorinated polymer” and/or to a “fluorinated aromatic compound” is intended to denote one or more than one polymer and/or aromatic compound. Mixtures of polymers and/or aromatic compounds can be advantageously used for the purposes of the invention.

The composition may comprise the at least one fluorinated polymer in the neutral form, wherein the expression “neutral form” indicates that in the —SO₂X functional groups X is X′ and X′ is selected from the group consisting of F, Cl, Br, I. Preferably X′ is selected from F or Cl. More preferably X′ is F.

Alternatively, the composition may comprise the at least one fluorinated polymer in the ionic (acid or salified) form, wherein the expression “ionic form” indicates that in the —SO₂X functional groups X is OM and M is selected from the group consisting of H, alkaline metals, NH₄.

For the avoidance of doubt, the term “alkaline metal” is hereby intended to denote the following metals: Li, Na, K, Rb, Cs. Preferably the alkaline metal is selected from Li, Na, K.

Fluorinated polymers comprising —SO₃M functional groups (wherein X=OM) are typically prepared from fluorinated polymers comprising —SO₂X′ functional groups, preferably —SO₂F functional groups, by methods known in the art.

The fluorinated polymer can be obtained in its salified form, i.e. wherein M is a cation selected from the group consisting of NH₄ and alkaline metals, by treatment of the corresponding polymer comprising—SO₂X′ functional groups, typically —SO₂F functional groups, with a strong base (e.g. NaOH, KOH).

The fluorinated polymer can be obtained in its acid form, i.e. wherein M is H, by treatment of the corresponding salified form of the polymer with a concentrated acid solution.

Suitable fluorinated polymers comprising —SO₂X′ functional groups are those polymers comprising recurring units deriving from at least one ethylenically unsaturated fluorinated monomer containing at least one —SO₂X′ functional group (monomer (A) as hereinafter defined) and recurring units deriving from at least one ethylenically unsaturated fluorinated monomer (monomer (B) as hereinafter defined).

The phrase “at least one monomer” is used herein with reference to monomers of both type (A) and (B) to indicate that one or more than one monomer of each type can be present in the polymer. Hereinafter the term monomer will be used to refer to both one and more than one monomer of a given type.

Non limiting examples of suitable monomers (A) are:
sulfonyl halide fluoroolefins of formula: CF₂═CF(CF₂)ₚSO₂X′ wherein p is an integer between 0 and 10, preferably between 1 and 6, more preferably p is equal to 2 or 3, and wherein preferably X′=F;
sulfonyl halide fluorovinylethers of formula: CF₂═CF—O—(CF₂)ₘSO₂X′ wherein m is an integer between 1 and 10, preferably between 1 and 6, more preferably between 2 and 4, even more preferably m equals 2, and wherein preferably X′=F;
sulfonyl halide fluoroalkoxyvinylethers of formula:

CF₂═CF—(OCF₂CF(R_{F1}))_{w}—O—CF₂(CF(R_{F2}))_{y}SO₂X′
wherein w is an integer between 0 and 2, R_{F1} and R_{F2}, equal or different from each other, are independently F, Cl or a C₁-C₁₀ fluoroalkyl group, optionally substituted with one or more ether oxygens, y is an integer between 0 and 6; preferably w is 1, R_{F1} is —CF₃, y is 1 and R_{F2} is F, and wherein preferably X′=F;
sulfonyl halide aromatic fluoroolefins of formula CF₂═CF—Ar-SO₂X′ wherein Ar is a C₅-C₁₅ aromatic or heteroaromatic substituent, and wherein preferably X′=F.

Preferably monomer (A) is selected from the group of the sulfonyl fluorides, i.e. wherein X′=F.

More preferably monomer (A) is selected from the group of the fluorovinylethers of formula CF₂═CF—O—(CF₂)ₘ—SO₂F, wherein m is an integer between 1 and 6, preferably between 2 and 4.

Even more preferably monomer (A) is CF₂═CFOCF₂CF₂—SO₂F (perfluoro-5-sulfonylfluoride-3-oxa-1-pentene).

Non limiting examples of suitable ethylenically unsaturated fluorinated monomers of type (B) are:
C₂-C₈ fluoroolefins, such as tetrafluoroethylene, pentafluoropropylene, hexafluoropropylene, and hexafluoroisobutylene;
vinylidene fluoride;
C₂-C₈ chloro- and/or bromo- and/or iodo-fluoroolefins, such as chlorotrifluoroethylene and bromotrifluoroethylene;
fluoroalkylvinylethers of formula CF₂═CFOR_{f1}, wherein R_{f1} is a C₁-C₆ fluoroalkyl, e.g. —CF₃, —C₂F₅, —C₃F₇;
fluoro-oxyalkylvinylethers of formula CF₂═CFOR_{O1}, wherein R_{O1} is a C₁-C₁₂ fluoro-oxyalkyl having one or more ether groups, for example perfluoro-2-propoxy-propyl;
fluoroalkyl-methoxy-vinylethers of formula CF₂═CFOCF₂OR_{f2} in which R_{f2} is a C₁-C₆ fluoroalkyl, e.g. —CF₃, —C₂F₅, —C₃F₇ or a C₁-C₆ fluorooxyalkyl having one or more ether groups, like —C₂F₅—O—CF₃;
fluorodioxoles, of formula:

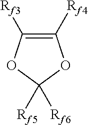

wherein each of R_{f3}, R_{f4}, R_{f5}, R_{f6}, equal or different each other, is independently a fluorine atom, a C₁-C₆ fluoro(halo)fluoroalkyl, optionally comprising one or more oxygen atom, e.g. —CF₃, —C₂F₅, —C₃F₇, —OCF₃, —OCF₂CF₂OCF₃.

Preferably monomer (B) is selected among:
C₃-C₈ fluoroolefins, preferably tetrafluoroethylene and/or hexafluoropropylene;
chloro- and/or bromo- and/or iodo-C₂-C₆ fluoroolefins, like chlorotrifluoroethylene and/or bromotrifluoroethylene;
fluoroalkylvinylethers of formula CF₂═CFOR_{f1} in which R_{f1} is a C₁-C₆ fluoroalkyl, e.g. —CF₃, —C₂F₅, —C₃F₇;
fluoro-oxyalkylvinylethers of formula CF₂═CFOR_{O1}, in which R_{O1} is a C₁-C₁₂ fluorooxyalkyl having one or more ether groups, like perfluoro-2-propoxy-propyl.

More preferably monomer (B) is tetrafluoroethylene.

The fluorinated polymer comprising —SO₂X′ functional groups may be prepared by any polymerization process known in the art. Suitable processes for the preparation of such polymers are for instance those described in U.S. Pat. No. 4,940,525 (THE DOW CHEMICAL COMPANY) Jul. 10, 1990 EP 1323751 A (SOLVAY SOLEXIS SPA) Jul. 2, 2003, EP 1172382 A (SOLVAY SOLEXIS SPA) Nov. 16, 2002.

In addition to the at least one fluorinated polymer comprising —SO₂X functional groups as defined above the composition comprises at least one fluorinated aromatic compound.

The term “fluorinated aromatic compound” is used in the present specification to indicate a fluorinated compound comprising at least one aromatic moiety comprising from 5 to 132 sp² hybridized carbon atoms or a total of from 5 to 120 sp² hybridized carbon atoms, nitrogen atoms, oxygen atoms and sulphur atoms, said aromatic moiety being free of hydrogen atoms bound to the sp² hybridized carbon atoms and to the nitrogen atoms, oxygen atoms and sulphur atoms, and comprising at least one fluorine atom bound to the sp² hybridized carbon atoms of the aromatic moiety.

The number of fluorine atoms bound to the sp² hybridized carbon atoms can be up to the number of sp² hybridized carbon atoms in the aromatic moiety. Preferably the aromatic moiety comprises at least two fluorine atoms, more preferably at least three fluorine atoms bound to the sp² hybridized carbon atoms in the aromatic moiety.

For the avoidance of doubts the expression “aromatic moiety” is used herein to denote a cyclic structure having a delocalized conjugated π system with a number of π delocalized electrons fulfilling Hückel's rule (number of π electrons=(4n+2), with n being an integer).

The at least one aromatic moiety in the fluorinated aromatic compound typically comprises from 5 to 60 sp² hybridized carbon atoms or a total of from 5 to 60 sp² hybridized carbon atoms, nitrogen atoms, oxygen atoms and sulphur atoms.

Preferably, the at least one aromatic moiety comprises from 6 to 60 sp² hybridized carbon atoms, more preferably from 6 to 48 sp² hybridized carbon atoms and even more preferably from 6 to 24 sp² hybridized carbon atoms.

Non-limiting examples of aromatic moieties include pyrrole, thiophene, benzene, pyridine, pyrazine, pyrazole, oxazole, naphtalene, anthracene, phenantrene, fluorene, pyrene, phenanthroline, triphenylene, quinoline.

The aromatic moiety may be substituted. Suitable substituents are electron withdrawing groups. Notable examples of electron withdrawing groups are halogens (Cl, Br, I); haloalkyls of the formula CₙH₍₂ₙ₋ₘ₋ₚ₊₁₎FₘZₚ, wherein Z is an halogen selected from Cl, Br, I; n is an integer from 1 to 12, m and p are independently zero or integers such as (m+p) is less than or equal to (2n+1); aryl or perfluoroaryl (e.g. pentafluorophenyl); amino; hydroxyl; nitro; cyano; carboxy; ester; —SO₂Y wherein Y is selected from F, Cl, Br, I.

The fluorinated aromatic compound may comprise one or more than one aromatic moiety. Should the fluorinated aromatic compound comprise more than one aromatic moiety, said aromatic moieties may be equal or different from each other.

The fluorinated aromatic compound may contain hydrogen atoms, provided they are not bound to the sp² hybridized carbon atoms and to the nitrogen atoms, oxygen atoms and sulphur atoms optionally present in the at least one aromatic moiety. Preferably the fluorinated aromatic compound is fully fluorinated.

Fluorinated aromatic compounds wherein the at least one aromatic moiety is benzene, that is a moiety having 6 sp² hybridized carbon atoms, have been found to be particularly advantageous in the preparation of the inventive compositions.

When the at least one aromatic moiety is benzene it comprises preferably three fluorine atoms, more preferably four fluorine atoms, even more preferably five fluorine atoms bound to the sp² hybridized carbon atoms in the benzene ring.

Non-limiting examples of suitable fluorinated aromatic compounds comprising benzene as an aromatic moiety are perfluorobenzene; perfluorobiphenyl; perfluorotoluene; perfluoro-p-quinquephenyl; perfluoro-p-sexiphenyl; 1,3,5 (pentafluorophenyl)-2,4,6 fluoro-benzene.

Among the fluorinated aromatic compounds comprising benzene as an aromatic moiety perfluorobenzene, perfluorobiphenyl or perfluorotoluene, in particular perfluorobiphenyl, have been found to be advantageous in the preparation of the inventive composition.

In a particular embodiment of the invention the at least one fluorinated aromatic compound as above defined comprises at least two substituents comprising functional groups which may react with the —SO₂X′ functional groups of the fluorinated polymer.

Notable examples of suitable functional groups which may react with the —SO₂X′ functional groups of the fluorinated polymer are those selected from the group consisting of —NHRₐ (wherein Rₐ=H, C₁-C₂₀ alkyl or fluoroalkyl, —Si(R_{b})₃, R_{b}=C₁-C₅ alkyl), —OH, —SO₂W (W=OH, F, Cl).

Preferably the at least two functional groups which may react with the —SO₂X′ functional groups of the fluorinated polymer are independently selected from —NHRₐ and wherein Rₐ is preferably selected from H and C₁-C₂₀ alkyl or fluoroalkyl, more preferably from H and C₁-C₅ alkyl or fluoroalkyl.

An advantageous class of fluorinated aromatic compounds comprising at least two substituents comprising functional groups which may react with the —SO₂X′ functional groups of the fluorinated polymer is represented by compounds of formula (I):

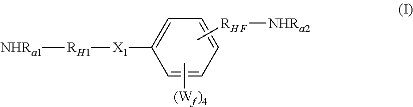

wherein: X₁ is an oxygen atom or a NH group; R_{H1} is a C₁-C₂₀, preferably C₁-C₆, alkylene or fluoroalkylene group; Rₐ₁ and Rₐ₂, equal or different from each other, are equal to Rₐ as defined above; R_{HF} is a C₁-C₂₀, alkylene or fluoroalkylene group, optionally comprising cyclic or aromatic moieties, optionally comprising heteroatoms in the alkylene chain, e.g. O, NH; and wherein W_{f} is a fluorine atom or a C₁-C₆ perfluoroalkyl group, preferably a fluorine atom. Is is understood that in formula (I) R_{HF} can be bound to the aromatic ring in any position (ortho, meta, para).

Notable examples of suitable groups R_{HF} may selected from those of formulas R_{HF1} and R_{HF2} below:

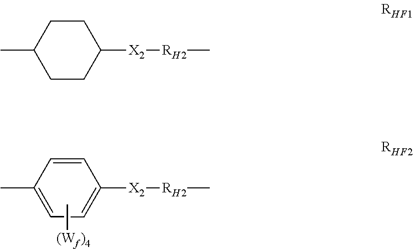

wherein X₂ is selected from O or NH and can be equal or different from X₁ and wherein R_{H2}, equal or different from R_{H1}, is a C₁-C₂₀, preferably C₁-C₆, alkylene or fluoroalkylene group. The cyclohexane ring in formula R_{HF1} may be partially or fully fluorinated.

Among compounds of formula (I) compounds complying with formula (II) below have been found to be advantageous for use in the preparation of ion exchange membranes.

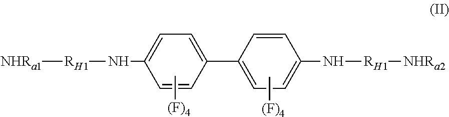

In formula (II) Rₐ₁ and Rₐ₂ are as defined above and can be equal or different from each other; each R_{H1}, equal or different from each other, have the meaning defined above. Preferably in formula (II) Rₐ₁ and Rₐ₂ are hydrogen and each R_{H1} is a C₁-C₆, alkylene group, preferably C₁-C₄, alkylene group, more preferably a C₂, alkylene group.

In a further embodiment of the invention the at least one fluorinated aromatic compound may be a polymer, said polymer comprising at least one aromatic moiety.

Non-limiting examples of suitable fluorinated aromatic compounds which are polymers are for instance those described in EP 2100909 A (SOLVAY SOLEXIS) Sep. 16, 2009 and complying with formulae (III)-(V) here below:

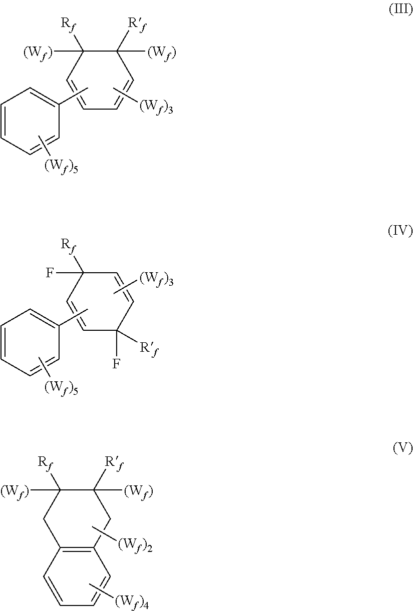

wherein: R_{f} and R′_{f}, equal or different from each other are fluoropolyoxyalkylene chains bound to a sp³ hybridized carbon atom either via an ether linkage or a C—C bond, optionally bound at their distal end group to another sp³ hybridized carbon atom of a further non-aromatic cyclic moiety; and W_{f} is a fluorine atom or a C₁-C₆ perfluoroalkyl group.

The fluorinated aromatic compound is present in the composition in any amount sufficient to reduce the degree of radical degradation of the fluorinated polymer.

Typically the amount of fluorinated aromatic compound is such that the total moles of the aromatic moiety in the composition per gram of fluorinated polymer are at least 0.005% (0.00005 total moles of aromatic moiety per gram of fluorinated polymer), preferably at least 0.01%, more preferably at least 0.015%.

The total moles of aromatic moieties in the composition per gram of the fluorinated polymer typically does not exceed 1%, preferably it does not exceed 0.8%, more preferably it does not exceed 0.5%. Higher amounts of the fluorinated aromatic compound may be added to the inventive composition however they would not give any additional benefit in terms of reduction in the degree of radical degradation of the fluorinated polymer.

When fluorinated aromatic compound in the inventive composition is selected from the group consisting of perfluorobenzene, perfluorobiphenyl, perfluorotoluene suitable amounts have been found to be in the range of from 0.01 to 0.15% moles of the aromatic moiety per gram of fluorinated polymer.

The composition may further comprise one or more additional compounds capable to i) either decompose hydrogen peroxide, and/or ii) trap the radical species formed during the functioning of the fuel cell.

Notable examples of compounds of type i) are for instance salts, oxides or organometallic complexes of metals selected from Al, Ce, Co, Fe, Cr, Mn, Cu, V, Ru, Pd, Ni, Mo, Sn and W, preferably Ce, Mn, Al, as well as mixtures of Ce and Mn. The metals are typically added to the composition comprising the fluorinated polymer and the fluorinated aromatic compound in amounts of from 0.1 to 3.0 mol %, preferably from 0.5 to 2.0 mol % relative to the moles of —SO₂X groups in the polymer.

Notable examples of compounds of type ii) are for instance hindered amines, hydroxylamines, arylamines, phenols, phosphites, benzofuranones, salicylic acid, azulenyl nitrones and derivatives thereof, tocopherols, cyclic and acyclic nitrones, ascorbic acid.

The composition may be prepared using conventional methods.

When both the fluorinated polymer and the fluorinated aromatic compound are provided in solid form, for instance in the form of powder, pellets or granules the composition may be prepared using techniques such as dry blending, melt blending, or extrusion.

Alternatively the fluorinated polymer and the fluorinated aromatic compound may be blended in the presence of a suitable solvent to provide a liquid composition. This method is advantageous for the preparation of compositions wherein the fluorinated polymer comprises —SO₃M functional groups, wherein M is as defined above, and in particular —SO₃H functional groups.

The liquid composition may be prepared by a dissolution process wherein fluorinated polymer is contacted with a liquid medium under suitable temperature conditions.

Generally, the liquid composition comprises a water or water/alcoholic mixture as liquid medium, optionally comprising additional ingredients and/or additives.

Suitable alcohols which can be used, in particular as water/alcoholic mixture, are notably methanol, ethanol, propyl alcohols (i.e. isopropanol, n-propanol), ethylene glycol, diethylene glycol.

Other liquid media that can be used are polar aprotic organic solvents such as ketones, like acetone, methylethylketone, esters, like methylacetate, dimethylcarbonate, diethylcarbonate, ethylacetate, nitriles, like acetonitrile, sulphoxides, like dimethylsulfoxide, amides, like N,N-dimethylformamide, N,N-dimethylacetamide, pyrrolidones, like N-methylpyrrolidone, N-ethylpyrrolidone.

Good results have been obtained with liquid compositions wherein the liquid medium is water or a mixture of water and alcohol, preferably of water and propyl alcohol(s).

The liquid composition may advantageously be prepared by contacting the fluorinated polymer with water or a mixture of water and alcohol, at a temperature of from 40° C. to 300° C. in an autoclave.

The fluorinated aromatic compound may be added to the liquid composition comprising the fluorinated polymer pure or after having been previously dissolved in a solvent, such as those described above.

A further object of the invention is a liquid composition comprising: at least one fluorinated polymer comprising —SO₂X functional groups and at least one fluorinated aromatic compound dispersed or dissolved in a liquid medium. Typically the liquid medium is water or a mixture of water and alcohol.

Preferably the fluorinated polymer in the liquid composition is in its ionic form, that is it comprises —SO₃M functional groups, wherein M is as defined above, and in particular —SO₃H functional groups.

The liquid composition comprising the at least one fluorinated polymer and the at least one fluorinated aromatic compound may optionally comprise additional ingredients. Mention can be made of non-ionic surfactants like TRITON® surfactant, TERGITOL® surfactant; as well as thermoplastic fluorinated polymers, typically having film-forming properties. Among thermoplastic fluorinated polymers which can be used in combination with the fluorinated polymer comprising —SO₂X functional groups in the liquid composition, mention can be made of PFA, ETFE, PCTFE, PDVF, ECTFE, and the like.

The composition of the invention is particularly suitable for the preparation of ion conducting membranes for use in fuel cell applications as the presence of the fluorinated aromatic compound has shown to improve the resistance of the membrane towards radical degradation as shown by the longer lifetime of the membrane at the conditions of use.

A third object of the present invention is therefore an article, in particular a membrane comprising at least one fluorinated polymer comprising —SO₂X functional groups and at least one fluorinated aromatic compound as defined above.

Compositions comprising the at least one fluorinated polymer, typically comprising —SO₂X′ functional groups, preferably —SO₂F functional groups, and the at least one aromatic compound in solid form may advantageously be converted into membranes by conventional extrusion techniques.

The extruded films can subsequently be converted into ion conducting membranes by hydrolysis, i.e. conversion of the —SO₂X′ functional groups into the corresponding —SO₃H functional groups, as discussed above.

Membranes can be obtained from liquid compositions comprising the at least one fluorinated polymer, typically comprising —SO₃M functional groups, preferably —SO₃H functional groups, and the at least one aromatic compound using techniques known in the art, such as impregnation, casting, coating, e.g. roller coating, gravure coating, reverse roll coating, dip coating, spray coating.

The membranes of the present invention may optionally be reinforced, for instance by lamination of the extruded membrane to a suitable reinforcing support or by impregnation of the liquid composition onto a porous support.

Suitable supports may be made from a wide variety of components. The porous supports may be made from hydrocarbon polymers such as woven or non-woven polyolefin membranes, e.g. polyethylene or polypropylene, or polyesters, e.g. poly(ethylene terephthalate). Porous supports of fluorinated polymers are generally preferred for use in fuel cell applications because of their high chemical inertia. Biaxially expanded PTFE porous supports (otherwise known as ePTFE membranes) are among preferred supports. These supports are notably commercially available under trade names GORE-TEX®, TETRATEX®.

All definitions and preferences defined previously within the context of the inventive composition apply to the process for preparing the composition, to the liquid composition as well as to any article containing said composition.

The invention will be now described in more detail with reference to the following examples, whose purpose is merely illustrative and not intended to limit the scope of the invention.

Should the disclosure of any of the patents, patent applications, and publications that are incorporated herein by reference conflict with the present description to the extent that it might render a term unclear, the present description shall take precedence.

### EXAMPLES

### Example 1

### Preparation of a Fluorinated Polymer (P1) Comprising —SO₃H Functional Groups

In a 22 l autoclave the following reagents were charged:
11.5 l of demineralised water;
980 g of the monomer with formula: CF₂═CF—O—CF₂CF₂—SO₂F
3100 g of a 5% weight solution of CF₂ClO(CF₂CF(CF₃)O)ₙ(CF₂O)ₘCF₂COOK in water (average molecular weight=521, ratio n/m=10).

The autoclave, stirred at 470 rpm, was heated at 60° C. A water based solution with 6 g/l of potassium persulfate was added in a quantity of 150 ml. The pressure was maintained at a value of 12 bar (abs) by feeding tetrafluoroethylene.

After adding 1200 g of tetrafluoroethylene in the reactor, 220 g of the monomer CF₂═CF—O—CF₂CF₂—SO₂F were added every 200 g of tetrafluoroethylene fed to the autoclave.

The reaction was stopped after 280 min by stopping the stirring, cooling the autoclave and reducing the internal pressure by venting the tetrafluoroethylene; a total of 4000 g of tetrafluoroethylene were fed.

The latex was then coagulated by freezing and thawing and the recovered polymer was washed with water and dried at 150° C. for 24 hours. The polymer was then treated with fluorine gas in a metallic vessel for 8 hours at 80° C., then purged several hours with nitrogen to remove any residual unstable end-groups.

The polymer thus obtained was immersed in a KOH solution (10% by weight) at 80° C. for 8 hours to convert the —SO₂F functional groups into —SO₃K functional groups, followed by washing in demineralised water at room temperature.

Immersion in a HNO₃ solution (20% by weight) at room temperature for 2 hours, followed by washing in demineralised water at room temperature converted the —SO₃K functional groups into —SO₃H functional groups.

The resulting fluorinated polymer in —SO₃H form (P1) was then dried in a vacuum oven at 80° C. The equivalent weight of the polymer (EW) was determined (by IR analysis on the precursor polymer) to be 790 g/eq.

### Example 2

### Preparation of Liquid Compositions C1 to C6 of P1 and of P1 and C₁₂F₁₀

A liquid composition (C1) comprising the fluorinated polymer of Example 1 and water was prepared following the procedure described in U.S. Pat. No. 4,433,082 (DU PONT) Feb. 21, 1984 using an autoclave model LIMBO 350 (Buchi Glas Uster) at 250° C. The liquid composition contained 30% by weight of polymer P1.

Decafluorobiphenyl was dissolved in acetone and then added under stirring to the liquid composition of Cl prepared as described above.

Composition C6 additionally contained cerium (III) ions added under the fomr of Ce(NO₃)₃.6H₂O.

The following compositions were prepared (all percentages being by weight with respect to the total weight of the composition):
C2-C4: acetone 31.9%, water 30.4%, n-propanol 23.7%, P1 13.5%, C₁₂F₁₀ 0.5%;
C5: acetone 54%, water 20%, n-propanol 16%, P1 9%, C₁₂F₁₀ 1%.
C6: acetone 32%, water 30%, n-propanol 17%, P1 14%, N-ethyl pyrrolidone 6%; C₁₂F₁₀ 0.54%, Ce(III) 0.02%.

### Example 3

### Preparation of N,N′-di(2-aminoethyl)-p,p′-octafluorobiphenylamine (2-NH₂—OFBF)

60 g of demineralised water, 300 g of ethanol and 60 g of ethylenediamine (1000 mmol) were placed in a 500 ml glass reactor equipped with condenser and magnetic stirrer, under inert atmosphere (nitrogen). 30 g (90 mmol) of decafluorobiphenyl were added to the reaction mixture after 5 minutes of stirring at room temperature.

The mixture was heated to reflux temperature (about 80° C.) and then stirred for 11 hours.

The mixture was distilled at a temperature of up to 90° C. in a rotary evaporator, under nitrogen flow (5 NI/h), to remove ethanol: the reaction product became insoluble in the residue of distillation and was recovered by filtration. It was then washed three times with demineralised water and then dried in a oven at 100° C. for 3 hours: 35 g of product was obtained.

The product was dissolved in acetone and characterized by NMR (¹⁹F NMR spectra were recorded on Varian Mercury 300 MHz spectrometer) which confirmed a molar purity higher than 97% in 2-NH₂—OFBF.

### Example 4

### Preparation of Liquid Compositions C7 and C8 of P1 and 2-NH₂—OFF

2-NH₂—OFBF (g) prepared in Example 3 was added under stirring to a liquid composition obtained by adding water, 1-propanol and N-ethyl pyrrolidone to the liquid composition Cl prepared as described above.

A second composition was similarly obtained by adding 2-NH₂—OFBF and Ce(NO₃)₃.6H₂O to the diluted liquid composition Cl.

The following compositions were prepared (all percentages being by weight with respect to the total weight of the composition):
C7: water 45%, n-propanol 35%, P1 15%, N-ethyl pyrrolidone 5%; 2-NH 2-OBF 0.16%
C8: water 45%, n-propanol 35%, P1 15%, N-ethyl pyrrolidone 5%; 2-NH 2-OFBF 0.16%, Ce(III) 0.02%

### Example 5

### Preparation of Membranes from the Liquid Compositions C1-C8

Foamed PTFE supports (TETRATEX #3101), having an average pore diameter of 0.2 μm (specified from the manufacturer) and a thickness of 35 μm, mounted on a PTFE circular frame having an internal diameter of 100 mm, were immersed in each liquid composition (C1-C8) and then dried in oven at a temperature of 65° C. for 1 hour, at 90° C. for 1 hour and then from 80 to 190-210° C. in 1 hour.

The impregnated supports were transparent and colourless indicating full occlusion of the pores of the support.

The thickness of the resulting membranes (referred to as M1 to M8) was in the range of from 15 and 30 μm.

### Example 6

### Fuel Cell Characterization of Membranes M1, M3-M6 and M8 Prepared in Example 5

Membranes M1, M3-M6 and M8 were assembled in a single cell (Fuel Cell Technology®) with an active area of 25 cm² and tested on an Arbin® 50 W test stand. The membranes were assembled with E-TEK LT250EW gas diffusion electrodes (0.5 mg/cm² Pt).

The test operating conditions were fixed as follow:
Reactants stoichiometry: 2.8 air-3.4H₂ (pure H₂ 5.5 grade)
Reactant humidity level: 100%
Cell temperature: 75° C.
Operating pressure: 2.5 bar (abs)

After 24 hours conditioning at a fixed voltage of 0.6 V a polarization curve was measured to verify the membrane performance. The conductivity of membranes M3-M6 and M8 was found not to differ from the conductivity of reference membrane M1.

Then the membranes were tested at the following operating conditions:
Anode side flow: 500 sccm pure H₂, 64° C. dew point, 1 bar (abs)
Cathode side flow: 500 sccm pure 0₂, 64° C. dew point, 1 bar (abs)
Cell temperature: 90° C.
Open circuit voltage condition (=current zero ampere).

The voltage was monitored during the test. The end of test was determined to be a voltage below 0.7 V, which is typically assumed to indicate the formation of pinholes in the membrane. The results are reported in Table 1.

TABLE 1

| | Time to reach voltage <0.7 V |
|---|---|
| Membrane | (hours) |
| M1 (reference) | 230 |
| M3 | 550 |
| M4 | 540 |
| M5 | 540 |
| M6 | 750 |
| M8 | 640 |

With respect to a membrane comprising fluorinated polymer (P1) alone (reference membrane M1) the membranes obtained from the compositions of the invention (M3-M6, M8) show a significant increase in stability under fuel cell operating conditions.

### Example 7

### Fenton's Test

The stability and durability of fluorinated ion exchange membranes has been generally assessed with reference to Fenton's tests, wherein the amount of fluoride ions released as a consequence of the treatment of the fluorinated membrane with hydrogen peroxide in the presence of iron (II) ions (catalyzing H₂O₂ decomposition in —OH radicals) is determined.

The test was carried out according to the following procedure: a specimen of roughly 0.3 g of each of membrane M1 and M2 was exposed for 5 hours at 50° C. to a solution of H₂O₂ at 15% containing 0.05 g of Fe(NH₄)₂(SO₄)₂. The fluoride content of the solution was then quantified via ion chromatography and expressed in percentage of eluted fluoride ions (F⁻) on the total amount of fluorine of the tested material. The results are reported in Table 2.

TABLE 2

| Membrane | Fluoride ions (ppm) |
|---|---|
| M1 (reference) | 3 |
| M2 | 1.5 |

The lower amount of eluted fluoride ions detected by the Fenton's test from membrane M2 confirms that the membrane obtained from the inventive composition shows a higher stability to peroxide degradation with respect to the reference membrane (M1) that does not contain the fluorinated aromatic compound.

1. A composition comprising:
at least one fluorinated polymer comprising —SO₂X functional groups, wherein
X is selected from X′ or from OM and
wherein X′ is selected from the group consisting of F, Cl, Br, and I; and
M is selected from the group consisting of H, alkaline metals, and NH₄, and
at least one fluorinated aromatic compound.

2. The composition according to claim 1, wherein the fluorinated aromatic compound comprises at least one aromatic moiety comprising from 5 to 132 sp² hybridized carbon atoms or a total of from 5 to 120 sp² hybridized carbon atoms, nitrogen atoms, oxygen atoms and sulphur atoms, said aromatic moiety being free of hydrogen atoms bound to the sp² hybridized carbon atoms and to the nitrogen atoms, oxygen atoms and sulphur atoms and comprising at least one fluorine atom bound to the sp² hybridized carbon atoms of the aromatic moiety.

3. The composition according to claim 1, wherein the fluorinated aromatic compound comprises at least two substituents comprising functional groups which may react with the —SO₂X′ functional groups of the fluorinated polymer.

4. The composition according to claim 1, wherein the at least one aromatic moiety is benzene.

5. The composition according to claim 1, wherein the at least one fluorinated aromatic compound is selected from the group consisting of perfluorobenzene, perfluorobiphenyl, perfluorotoluene, perfluoro-p-quinquephenyl, perfluoro-p-sexiphenyl, 1,3,5 (pentafluorophenyl)-2,4,6 fluoro-benzene, and from the compounds of formula (I) 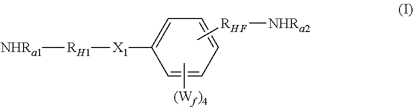
wherein X₁ is an oxygen atom or a NH group; R_{H1} is a C₁-C₂₀ alkylene or fluoroalkylene group; Rₐ₁ and Rₐ₂, equal or different from each other, are selected from the group consisting of H, C₁-C₂₀ alkyl or fluoroalkyl, and —Si(R_{b})₃, wherein R_{b} is C₁-C₅ alkyl; R_{HF} is a C₁-C₂₀ alkylene or fluoroalkylene group, optionally comprising cyclic or aromatic moieties, optionally comprising heteroatoms in the alkylene chain; and wherein W_{f} is a fluorine atom or a C₁-C₆ perfluoroalkyl group.

6. The composition of claim 1, wherein the at least one fluorinated aromatic compound is a polymer comprising at least one aromatic moiety.

7. The composition according to claim 1, wherein the at least one fluorinated aromatic compound is present in an amount such that the total number of moles of the aromatic moiety in the composition per gram of fluorinated polymer is at least 0.005% and does not exceed 1%.

8. A liquid composition comprising the composition of claim 1, dispersed or dissolved in a liquid medium.

9. The liquid composition of claim 8, wherein X is OM and M is H in the fluorinated polymer.

10. A process for the preparation of a composition according to claim 1, comprising blending the at least one fluorinated aromatic compound and the at least one fluorinated polymer in solid form or in a solution.

11. A membrane comprising the composition of claim 1.

12. The membrane according to claim 11 further comprising a support.

13. The membrane according to claim 12 wherein the support is a porous support made of a fluorinated polymer.

14. A process for the preparation of the membrane of claim 11, the process comprising extruding a composition comprising:
at least one fluorinated polymer comprising —SO₂X functional groups, X is X′ wherein X′ is selected from the group consisting of F, Cl, Br, and I; and
at least one fluorinated aromatic compound.

15. A process for the preparation of the membrane of claim 11, the process comprising impregnating, casting or coating a liquid composition comprising:
at least one fluorinated polymer comprising —SO₂X functional groups, wherein
X is selected from X′ or from OM and
wherein X′ is selected from the group consisting of F, Cl, Br, and I; and
M is selected from the group consisting of H, alkaline metals, and NH₄ and
at least one fluorinated aromatic compound dispersed or dissolved in a liquid medium.

16. A fuel cell comprising the membrane of claim 11.

17. The composition according to claim 5, wherein R_{H1} is a C₁-C₆ alkylene or fluoroalkylene group.

18. The composition according to claim 5, wherein W_{f} is a fluorine atom.

19. The composition according to claim 5, wherein the at least one fluorinated aromatic compound is selected from the group consisting of compounds of formula (II): 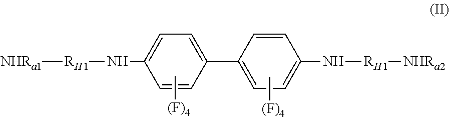
wherein each Rₐ₁ and Rₐ₂ are independently hydrogen and each R_{H1} is independently a C₁-C₆ alkylene group.

20. The composition according to claim 19, wherein the fluorinated aromatic compound is selected from decafluorobiphenyl and N,N′-di(2-aminoethyl)-p-p′-octafluorobiphenylamine.
